(19) United States
(12) Patent Application Publication
(10) Pub. No.: US 2012/0176252 A1
(43) Pub. Date: Jul. 12, 2012

(54) Apparatus and Method for Determining Load of Energy Consuming Appliances Within a Premises

(75) Inventors: David Scott Drew, St. Louis, MO (US); Xingwen Luo, Xi'an (CN)

(73) Assignee: EMERSON ELECTRIC CO., St. Louis, MO (US)

(21) Appl. No.: 13/370,095

(22) Filed: Feb. 9, 2012

Related U.S. Application Data
(63) Continuation-in-part of application No. 13/005,306, filed on Jan. 12, 2011.

(51) Int. Cl. G08C 15/06; G06F 1/28; G05D 23/19; G06T 11/20; G09G 5/34

(52) U.S. Cl. 340/870.02; 345/440; 345/684; 700/278

(57) ABSTRACT

Disclosed herein are exemplary embodiments of apparatus and methods for determining load of energy consuming appliances within a premises. An exemplary embodiment includes a thermostat operable for displaying information relating to energy consumption associated with an energy consuming load in a premise. In this exemplary embodiment, the thermostat includes a display device and a processor. The processor is configured to receive a signal including energy consumption information. The processor is further configured to control the display device to display a graph indicating an estimated cost of energy consumed for days within a given month.

### CROSS-REFERENCE TO RELATED APPLICATION

This application is a continuation-in-part of U.S. patent application Ser. No. 13/005,306 filed Jan. 12, 2011. The entire disclosure of the above application is incorporated herein by reference.

### FIELD

The present disclosure relates to thermostats for controlling operating of a heat-pump or air-conditioning unit, which thermostats may be configured to provide demand side management to an electric utility provider.

### BACKGROUND

This section provides background information related to the present disclosure which is not necessarily prior art.

As the demand for electrical power increases during the day, the utility provider experiences an increase in the cost of generating electrical power as a result of secondary peak power plants that are switched on to supplement off-peak power generating plants. Many utility providers establish demand response programs to reduce energy demand as an alternative to building more plants.

In situations where the peak demand begins to exceed the capacity of the utility provider's peak and off-peak power plants, the utility provider may engage in demand side management. This may include curtailing operation of air-conditioning units to reduce demand for electrical power during peak demand periods in an effort to keep energy demand from exceeding capacity.

Utility providers engaging in demand side management may transmit a signal to a thermostat to control an air-conditioning unit to reduce the amount of energy used in peak demand periods. But the utility provider may have little idea about how much load it is reducing by setting back a temperature setting or shutting off random air-conditioning units, and thus may not succeed in actually curbing energy consumption despite its efforts.

### SUMMARY

This section provides a general summary of the disclosure, and is not a comprehensive disclosure of its full scope or all of its features.

Disclosed herein are exemplary embodiments of apparatus and methods for determining load of energy consuming appliances within a premises. An exemplary embodiment includes a thermostat for monitoring energy consumption associated with an HVAC unit having a compressor. In this exemplary embodiment, the thermostat includes a sensor, a processor, and a display device. The sensor is operable for providing an output indicative of a temperature within a space of a premises. The processor is operable for controlling activation of at least the compressor of the HVAC unit to control temperature in the space relative to a desired set-point temperature. The processor is configured to receive energy consumption information from a utility meter for the premises prior to activation of the compressor and subsequent to activation of the compressor. The processor is further configured to estimate energy consumption of the HVAC unit based at least in part upon the difference between the energy consumption prior to activation and the energy consumption subsequent to activation of the compressor. The display device is operable for displaying a graph indicating estimated cost of energy consumed by the HVAC unit for days within a given month.

Another exemplary embodiment includes a thermostat operable for displaying information relating to energy consumption associated with an energy consuming load in a premise. In this exemplary embodiment, the thermostat includes a display device and a processor. The processor is configured to receive a signal including energy consumption information. The processor is further configured to control the display device to display a graph indicating an estimated cost of energy consumed for days within a given month.

Another exemplary embodiment includes a system for monitoring energy consumption for an energy consuming load in a premises that is supplied with power monitored by a utility meter. In this exemplary embodiment, the system includes a thermostat including a display device. A gateway is provided for connection with the thermostat, for enabling connection via the internet to a website. The gateway includes a transmitter and a receiver. The transmitter is operable for transmitting wireless signals to a utility meter for the premises to request energy consumption information. The receiver is operable for receiving wireless signals including energy consumption information from the utility meter. At least one of the gateway and/or the thermostat is configured to estimate energy consumption of the energy consuming load based at least in part upon a difference between energy consumption during operation and energy consumption during non-operation of the energy consuming load. The display device is operable for displaying a graph indicating estimated cost of energy consumed by the energy consuming load for days within a given month.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an illustration of a premises including one or more controllers configured to determine an estimate of the energy consumption level associated with one or more energy consuming appliances for a premises;

FIG. 2 is a schematic illustration of exemplary embodiment of a thermostat configured to determine an estimate of the energy consumption level associated with a heat-pump or air-conditioning unit in accordance with the present disclosure;

FIG. 3 is a flow chart illustrating operation of the exemplary embodiment of the thermostat shown in FIG. 1 in accordance with the present disclosure;

FIG. 4 illustrates the exemplary embodiment of the thermostat shown in FIG. 1 displaying a cost estimate for energy consumed by an appliance;

FIG. 5 shows the thermostat in FIG. 4 displaying a graph of daily energy consumption for an appliance; and

FIGS. 6 and 7 show the thermostat in FIG. 4 displaying selection of a given day within the graph of daily energy consumption for an appliance.

Corresponding reference numerals indicate corresponding parts throughout the several views of the drawings.

### DETAILED DESCRIPTION

Example embodiments will now be described more fully with reference to the accompanying drawings.

Various exemplary embodiments are disclosed herein of control systems, apparatus, or controllers for determining energy consumption levels or loads of energy consuming appliances and devices. In an exemplary embodiment, a controller (e.g., thermostat, etc.) is in communication with one or more energy consuming loads or appliances for a premises, such as an HVAC unit including heat-pump or air-conditioning components, an electric water heater, a refrigerator, a pool pump, etc. The controller includes a processor configured to receive energy consumption information from a utility meter for the premises prior to activation of a compressor of an HVAC unit and subsequent to activation of the compressor. The processor is further configured to estimate the energy consumption of the HVAC unit based at least in part upon the difference between the energy consumption prior to activation and subsequent to activation of the compressor.

In another exemplary embodiment in which a controller is in communication with one or more energy consuming loads or appliances for a premises, the controller includes a transmitter device for transmitting wireless signals to a utility meter to request an energy consumption reading. Also in this example, the controller includes a receiver device to receive wireless signals including energy consumption information. The controller is configured to receive a signal from an energy consuming appliance indicating the appliance was actuated, and to responsively transmit a signal to the utility meter to request an energy consumption reading, and thereafter receive a signal including an energy consumption value. The controller is also configured to transmit a signal to the utility meter to request an energy consumption reading following deactivation of the appliance, and to thereafter receive a signal from the utility meter including another energy consumption value. The controller is further configured to determine from a difference between the energy consumption values an estimate of the energy consumption level associated with the appliance.

According to another aspect of the present disclosure, exemplary embodiments of thermostats are disclosed for monitoring energy consumption associated with HVAC units having electrically powered compressors. In an exemplary embodiment, a thermostat includes a sensor operable to provides an output indicative of a temperature within a space of a premises. The thermostat also includes a processor for controlling activation of at least the compressor of the HVAC unit to control the temperature in the space relative to a desired set-point temperature. The processor is configured to receive energy consumption information from a utility meter for the premises prior to activation of the compressor and subsequent to activation of the compressor. The processor is further configured to estimate the energy consumption of the HVAC unit based at least in part upon the difference between the energy consumption prior to activation and subsequent to activation of the compressor. The thermostat further includes a display operable to display an indication of the energy consumption for the HVAC system based at least in part upon the estimate. Accordingly, this exemplary thermostat may thus display energy consumption of an HVAC unit or other appliance in communication with the thermostat or a gateway connected to the thermostat

In various exemplary embodiments of the present disclosure, controllers are disclosed that are operable for determining an estimate of the energy consumption associated with one or more energy consuming loads or appliances for a premises. This, in turn, may provide value in understanding how consumer behavior impacts energy consumption. With an estimate of the energy consumption, a consumer may make a more informed decision (e.g., turning off heating or air conditioning at night during sleeping house or prior to going away on vacation, etc.).

Also disclosed herein are exemplary embodiments of thermostats having display devices and processors. In an exemplary embodiment, a thermostat includes a processor configured to receive a signal including energy consumption information (e.g., energy consumption values, etc.). For example, the thermostat may include a receiver device to receive wireless signals including energy consumption information provided by a utility or energy provider, a sensor device for sensing current and/or voltage to an appliance, another energy monitoring sensor device that transmits signals including energy consumption information, etc. The thermostat's processor is further configured to control the display device to display a graph indicating an estimated cost of energy consumed for each day within a given month. The thermostat is configured to allow a user to select a day within the given month to view the estimated cost for that selected day. Accordingly, the thermostat may thus display an estimate of energy consumption associated with one or more energy consuming loads or appliances for a premise.

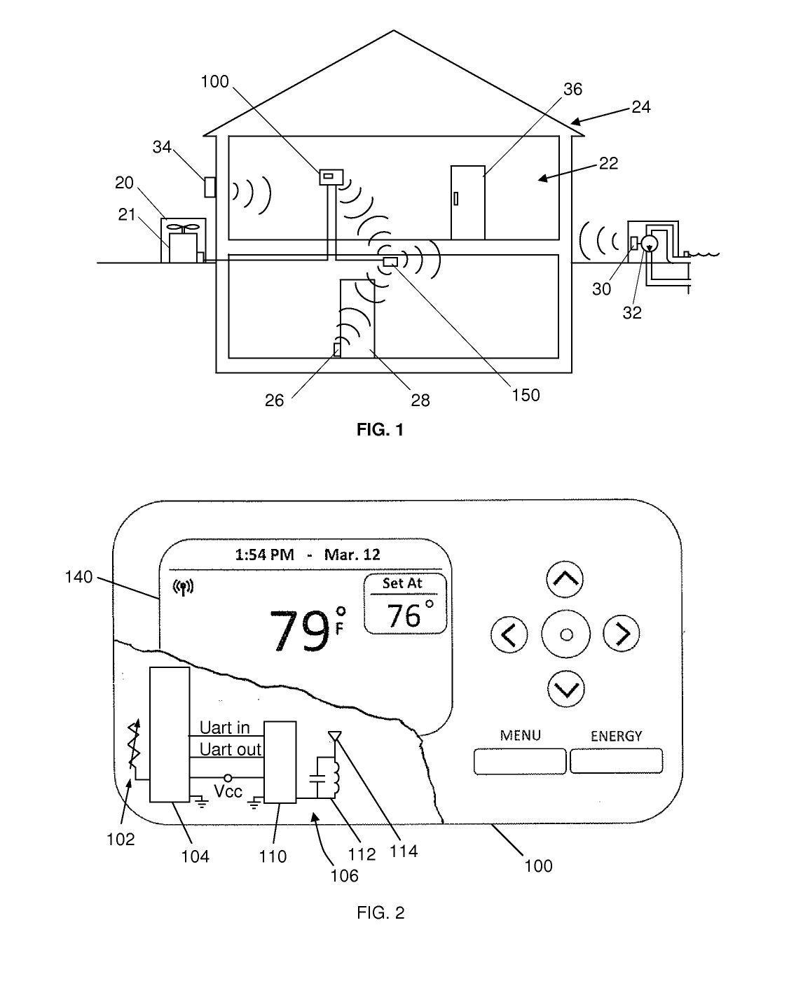

With reference now to the figures, FIG. 1 illustrates an exemplary embodiment of a thermostat 100 embodying one or more aspects of the present disclosure. In operation, the thermostat 100 may be used for determining the energy consumption level of a heat-pump or air-conditioning unit 20. As shown in FIG. 1, the thermostat 100 is connected to (or in communication with) the heat-pump or air-conditioning unit 20 (also generally referred to herein as HVAC unit or appliance) for heating or cooling a space 22 in a premises 24. The thermostat 100 may also be connected to or in communication with other system controllers. For example, and as shown in FIG. 1, the thermostat 100 is in communication with a controller 26 for an electric water heater 28 and a pump controller 30 for a pool water pump 32. In other exemplary embodiments, the thermostat 100 may be in communication with additional or different controllers.

Also shown in FIG. 1, the thermostat 100 may further be connected to a gateway 150 (or an ESI device) for enabling connection via the internet to a website. In this example, the gateway 150 is also shown in communication with a plurality of energy consuming appliances or loads, including the thermostat 100, electric water heater 28, pool water pump 32, and refrigerator 36. In other exemplary embodiments, the gateway 150 may also be in communication with additional or different energy consuming appliances or loads, such as a media center, etc.

A utility meter 34 is associated with the premises 24 in which the thermostat 100 is disposed. The utility meter 34 may be a utility meter with Advanced Metering Infrastructure (AMI), which can transmit wireless signals that include energy consumption information. Energy consumption information may comprise, for example, the rate of power usage (expressed in kilowatts for example) or the amount of energy or power used (expressed as kilowatt-hours, for example) as explained below.

By way of background, operating a compressor of an HVAC system requires electrical energy, which is usually measured and expressed in watt-hours. A watt is an electrical unit of power that is the rate of energy transfer. Thus, the rate of energy transferred to or used while operating the compressor is the power to the compressor that may be expressed in units of kilowatts. A watt-hour is an electric energy unit of measure equal to 1 watt of power supplied to, or used by, a load steadily for 1 hour. Thus, the energy consumption of a compressor over a period of time may be expressed in units of kilowatt-hours. The cumulative energy consumption expressed in units of kilowatt-hours may be determined from the product of the rate of energy usage expressed in kilowatts (e.g., power) and the duration of time that the compressor operated (e.g., hours), to arrive at a kilowatt-hour amount of energy consumed by a compressor over a period of time. Accordingly, energy consumption information (as used herein) may comprise power (expressed in kilowatts) as well as power consumed over a time period (expressed in kilowatt-hours).

The energy consumption information communicated by an electric utility meter may instead be provided or expressed in one or more forms. For example, the energy consumption reading may be a cumulative running total of the kilowatt-hours consumed for the premises. The difference between two such successive readings of kilowatt-hours used over a given time interval can be used to determine an amount of energy consumption (expressed as kilowatt-hours) for the time between the successive readings. The utility meter may also communicate energy consumption information that is representative of the present rate of energy usage (or power) expressed in kilowatts. The energy consumption expressed as kilowatt-hours may be determined from the product of the rate of energy usage (kilowatts) and the duration of time of operation (hours). Thus, the energy consumption of a compressor may be determined from the rate of energy usage expressed in kilowatts (e.g., power) and the duration of time that the compressor operated, to arrive at a kilowatt-hour amount of energy consumed by the compressor. With either form of energy consumption information provided by a utility meter (kilowatts or kilowatt-hours), it is possible to determine an estimate of the energy consumption for a period of operation of a compressor for a heat-pump/air-conditioning unit.

Referring now to FIG. 2, the illustrated thermostat 100 includes a sensor 102 that is capable of sensing a temperature in the space 22. The sensed temperature may be used in controlling the operation of a heat-pump or air-conditioning unit 20 (or HVAC unit) to condition the space 22. The thermostat 100 further includes a processor 104 in communication with the sensor 102. The processor 104 is operable for controlling activation and deactivation of at least a compressor 21 of the heat-pump or air-conditioning unit 20 (as shown in FIG. 1), for controlling the temperature within the space 22 relative to a desired set-point temperature.

Accordingly, the thermostat 100 (shown in FIG. 2) includes at least one sensor 102 or temperature responsive device, which periodically outputs a value indicative of the temperature in the space 22. The sensor 102 may be any of a number of sensor types. For example, the sensor 102 may comprise a crystal, oscillator, or other electronic device with a reactance or frequency that changes in response to temperature. Alternatively, the sensor 102 may comprise a thermistor having a resistance value that changes in response to changes in temperature. The sensor 102 could also be a device capable of communicating a voltage value that correlates to, or is indicative of, the temperature sensed in the space 22. The sensor 102 may include circuitry to permit the sensor to communicate a value indicative of the temperature that is accurate to a tenth of degree Fahrenheit. The sensor 102 may also include circuitry to enable communication of temperature information on a periodic basis or upon request, such as when prompted by a processor 104 of the thermostat 100. Accordingly, the sensor 102 is configured to sense and communicate information that is indicative of a temperature to a processor 104 having a program and a set-point temperature. And, the processor 104 is configured to control operation of the heat-pump or air-conditioning unit to adjust the sensed temperature in the space 22 to maintain or substantially maintain the set-point temperature.

With continued reference to FIG. 2, the thermostat 100 further includes a receiver device 106 configured to receive a signal transmitted by a utility meter (e.g., utility meter 34 shown in FIG. 1, etc.) outside the premises 24. The utility meter may utilize an Advanced Metering Infrastructure (AMI) for transmitting/receiving signals that include energy consumption information. The receiver device 106 is in communication with the processor 104 of the thermostat 100.

In the illustrated embodiment of FIG. 2, the receiver device 106 may further comprise a transmitter, which is configured to transmit wireless signals. The receiver device and transmitter may thus be referred to herein as a transceiver device 106. The transceiver device 106 is connected to the processor 104 of the thermostat 100, where the transceiver device 106 and processor 104 are connected to a low voltage power supply Vcc. The transceiver device 106 may generally comprise a transceiver chip 110, which may be connected to a resistor-capacitor filter circuit 112 and an antenna 114.

The transceiver device 106 is configured to receive wireless signals transmitted by the utility meter 34 for the premises 24. In an exemplary operation, the transceiver device 106 receives a signal from the utility meter 34 via the antenna 114, and may then compare the signal to a reference signal. For example, the signal may be compared to a local oscillator having a frequency of 418 millihertz, and then demodulated into a digital data stream. This data may then be output via a Universal Asynchronous Serial transmission (UART) communication link, and may be decoded and transmitted as a serial bit stream signal from a data port pin of the transceiver chip 110 to an input port pin (such as a UART Port) on the processor 104.

The processor 104 may be configured to load the signal data into a software buffer for protocol verification, and to strip the data and analyze a synchronization bit at the beginning of the signal to synchronize the signal and the utility meter 34 of the premises 24, for identifying the unique serial number within the transmission to verify signal protocol with a serial number for utility meter 34 of the premises 24. When protocol verification of a transmitted signal is complete and the signal for the utility meter 34 is verified, the processor 104 receives the signal data that includes energy consumption information.

In exemplary embodiments, the thermostat 100 may be configured to periodically receive utility meter signals including energy consumption information in a continuous manner, without transmitting a signal to the utility meter to request such information. In this configuration, the thermostat 100 may periodically receive energy consumption information at regularly spaced time intervals. Accordingly, the thermostat 100 may include the sensor 102 and processor 104 for controlling activation of at least a compressor of an HVAC unit to control the temperature in the space relative to a desired set-point temperature, where the processor 104 is configured to receive energy consumption information from a utility meter 34 for the premises 24 prior to activation of the compressor and subsequent to activation of the compressor. The processor 104 of the thermostat 100 is further configured to estimate the energy consumption of the HVAC unit based at least in part upon the difference between the energy consumption prior to activation and subsequent to activation of the compressor. The thermostat 100 further includes a display device 140 that displays an indication of the energy consumption associated with the operation of the HVAC system based at least in part upon the estimate. Where the energy consumption information received from the utility meter 34 is in terms of the rate of power usage (expressed in units of kilowatts), the difference between energy consumption prior to and subsequent to activation of the compressor is indicative of an increase in the rate of power usage by the HVAC unit, expressed in kilowatts.

In exemplary embodiments, the thermostat 100 is configured to monitor the duration of time in which the compressor is activated, and energy consumption information received from the utility meter 34 expressed in units of kilowatts, such that an estimate of consumption of the HVAC unit may be determined from the increase in the rate of power usage (kilowatts) and the time the HVAC unit was activated. Thus, the thermostat 100 is configured to receive via wireless signals from the utility meter 34 information that is indicative of consumption before and after deactivation of the compressor, which is used to estimate consumption of the HVAC unit based at least in part upon the difference between the energy consumption prior to and subsequent to deactivation of the compressor.

In another configuration in which the utility meter 34 does not continuously transmit signals including energy consumption information, the thermostat 100 includes a processor 104 configured to communicate via the transceiver device 106 (or receiver device and transmitter device) to the utility meter 34 to request energy consumption information prior to activation of the compressor, and to receive (via the receiver device 106) a first energy consumption value from the utility meter that is indicative of the energy consumption for the premises prior to activation of the compressor. After activation of the compressor, the processor 104 is configured to communicate via the transceiver device 106 (or receiver device and transmitter device) to the utility meter 34 to request energy consumption information after activation of the compressor, and to receive (via the receiver device 106) a second energy consumption value from the utility meter that is indicative of the energy consumption for the premises after activation of the compressor. Accordingly, the first energy consumption value and the second energy consumption value may each be readings of the rate of energy usage (e.g., kilowatts) for the premises, such that the difference between the first energy consumption value and the second energy consumption value is indicative of an increase in the rate of power usage (expressed in kilowatts) being used at the premises as a result of activation of the compressor of the HVAC unit. The energy consumption of the HVAC unit may be estimated or determined based on the increase in the rate of usage expressed in kilowatts (e.g., power) and the duration of time the compressor/HVAC unit was activated, to arrive at a kilowatt-hour amount of energy consumed by the HVAC unit.

The thermostat 100 may further configured to determine a second estimate of the energy consumption associated with the heat-pump or air-conditioning unit 20. After deactivation of the heat-pump or air-conditioning unit 20, the processor 104 of the thermostat 100 may be configured to communicate via the transmitter device to the utility meter 34 to request energy consumption information, and to receive via the receiver device 106 a third energy consumption value. In such exemplary embodiment, the processor 104 is further configured to determine a second estimate of the energy consumption for the HVAC unit from or by using a difference between the second energy consumption value and the third energy consumption value. In the determination of the second estimate, the difference between the second energy consumption value and the third energy consumption value is indicative of a decrease in the rate of power usage expressed in kilowatts as a result of the deactivation of the compressor of and/or HVAC unit. This decrease provides the second estimate of the information on the energy consumption associated with the HVAC unit. The determination of the energy consumption for the HVAC unit could then be determined based in part on the decrease in the rate of power usage expressed in kilowatts and the time duration that the HVAC unit was activated. Alternatively, where the energy consumption information received from the utility meter is expressed in units of kilowatt hours, the difference between the third energy consumption value and either the first or second energy consumption value would be indicative of the energy consumption of the HVAC unit (expressed in units of kilowatt-hours) for the time that the HVAC unit was activated.

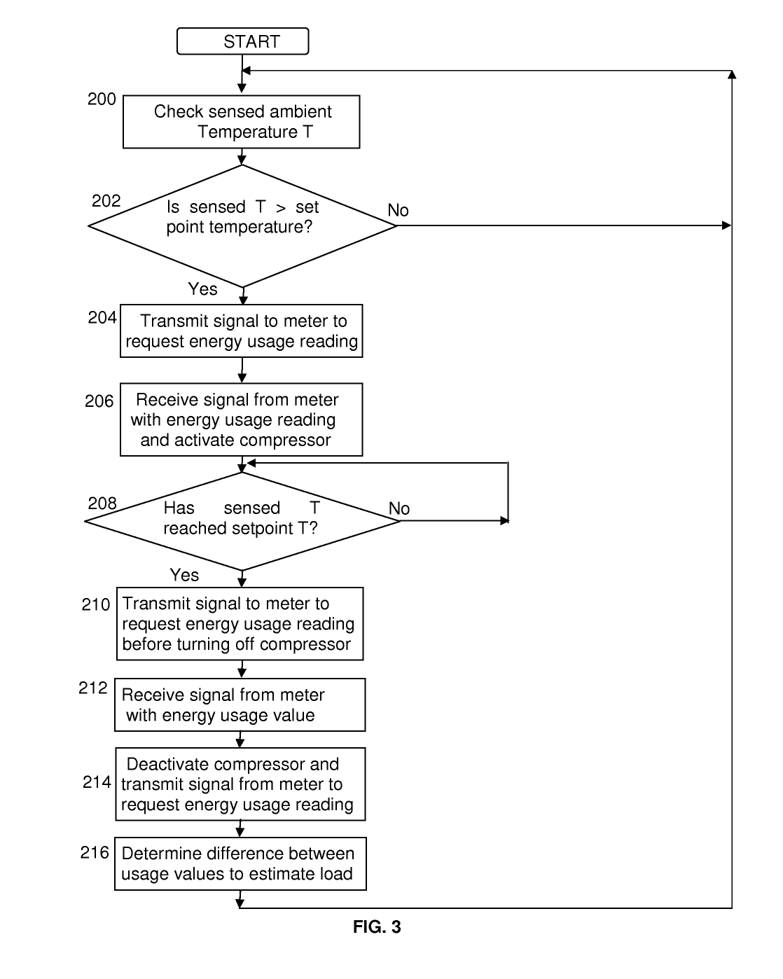

Referring to FIG. 3, a flow chart is shown illustrating various steps, processes, or operations of an example of the operational control of the processor 104 in a cooling mode for the thermostat 100 in FIG. 2. In this example, the processor 104 is configured to perform various steps, processes, or operations shown in FIG. 3. For example, the processor 104 is configured so as to check the sensed temperature (at step 200) and to determine if it is above a set-point temperature (at step 202). If the processor 104 determines that the sensed temperature is above the set-point temperature, then the processor 104 is configured to then transmit signals (at step 204) via the transceiver device 106 to the utility meter 34 for the premises 24 to request energy consumption information, such as an energy consumption reading. Prior to activation of the compressor 21 (e.g., within a predetermined time before activation), the processor 104 is configured to transmit a signal to the utility meter 34 to request an energy consumption reading and to receive a signal (at step 206) from the utility meter 34 including a first energy consumption value.

During operation of the compressor 21, the processor 104 is configured to determine when the sensed temperature has reached the set-point temperature (at step 208). When the set-point temperature is reached but before deactivation of the compressor 21, the processor 104 is configured to transmit a signal (at step 210) to the utility meter 34 to request an energy consumption reading, and to receive a signal (at step 212) from the utility meter 34 including a second energy consumption reading. After deactivation of the compressor 21 (at step 214), the processor 104 is configured to determine (at step 216), from a difference between the first energy consumption value and second energy consumption value, a first estimate of the energy consumption associated with the heat-pump or air-conditioning unit 20. The processor 104 is thereby able to determine a load profile for the heat-pump or air-conditioning unit 20. The thermostat 100 may further include the display device 140 (FIG. 2), which may be configured to display an indication of the energy consumption for the heat-pump or air-conditioning unit 20, as well as other information such as the sensed temperature within the premises 24.

With reference back to FIG. 1, the thermostat 100 may be configured to be operable for determining energy consumption level of an energy consuming load. As shown in FIG. 1, the thermostat 100 may further be connected to a gateway 150 for enabling connection via the internet to a website. In this exemplary embodiment of a system that includes the thermostat 100 and gateway 150, the thermostat 100 is configured to communicate the information on the energy consumption associated with the heat-pump or air-conditioning unit 20 to the gateway 150. Communication of energy consumption information for the heat-pump or air-conditioning unit 20 through the gateway 150 may then permit an energy service provider to access the information on the energy consumption associated with the heat-pump or air-conditioning unit 20. This, in turn, would then enable energy service providers seeking to shed load during peak demand periods by turning off air-conditioning units to evaluate which premises air-conditioning units use the most energy and would provide the most reduction in load.

Furthermore, many energy service provider entities would like to have access to disaggregated load information within residences and buildings. Utility companies and energy service providers are willing to invest significantly to implement demand response and energy efficiency programs. Disaggregated load information would enable them to greatly enhance efficacy of both types of programs.

Air-conditioning systems account for up to 75 percent of peak load. As such, understanding each home's air-conditioning load and thermal profile would offer utility companies and energy service providers tremendous value in optimizing how they mitigate peak demand. For example, a utility company may have 200,000 homes participating in demand response programs that allow a broadband signal to be sent to smart thermostats, which sets back the set-point temperature by 4 degrees Fahrenheit, or cycles on and off during peak demand periods. But the energy service provider has little idea about the specific load profile or efficiencies of each home. As such, the demand response programs are designed less than optimally, since a 4 degrees Fahrenheit set-back of a thermostat in a home with an inefficient compressor or poor insulation would shed far less load than one that has excellent insulation.

In an exemplary embodiment, a thermostat (e.g., thermostat 100, etc.) provides for polling the utility meter for the aggregate load of the premises directly before the appliance to be measured turns on to establish a data point A. The thermostat further polls the utility meter after the appliance is operating at its run rate or level of energy consumption, to establish data point B. Once the appliance turns off, the thermostat would poll the utility meter to establish data point C. Software associated with the processor of the thermostat would then determine a difference between the energy consumption levels for data points A and B, and data points B and C, to calculate the load profile of the appliance, such as a heat-pump or air-conditioning unit. The processor may be further configured to average the differences over an extended period of time, such as 30 days for example, to ascertain an accurate load profile for the appliance. By keeping an ongoing record of the heat-pump or air-conditioning unit's energy consumption or performance, the thermostat could inform the consumer when the residence or building is experiencing efficiency degradation, possibly due to low refrigerant charge or an antiquated compressor. For example, the ongoing data record could be used to detect degradation of the appliance's performance by comparison to historical data for the previous summer for determining a difference in consumption. This data record monitoring can be performed remotely, where the thermostat communicates data to a server at a remote location for processing. The thermostat could display the difference that the performance degradation will cost the user as an extra amount, or indicate how much the user could save by upgrading to a new system.

Understanding which homes have inefficient or high energy consumption air-conditioning units would enable energy service providers to have much more accuracy in determining the optimum operation of their demand response programs, such as by targeting homes with the highest energy consumption air-conditioning units. Accordingly, in exemplary embodiments disclosed herein, a thermostat (e.g., thermostat 100, etc.) is configured to receive via a gateway (e.g., gateway 150, etc.) a signal from an energy service provider requesting curtailment of operation of the heat-pump or air-conditioning unit (e.g., heat-pump or air-conditioning unit 20, etc.) based on the information on the energy consumption associated with the heat-pump or air-conditioning unit. Additionally, energy efficiency implementation firms, such as White-Rodgers Division of Emerson Electric Co., may also use this information to target homes that are most in need of equipment upgrades or service. The utility company could be provided with an incentive to pay for efficiency upgrade programs for such homes that are in need of equipment upgrades.

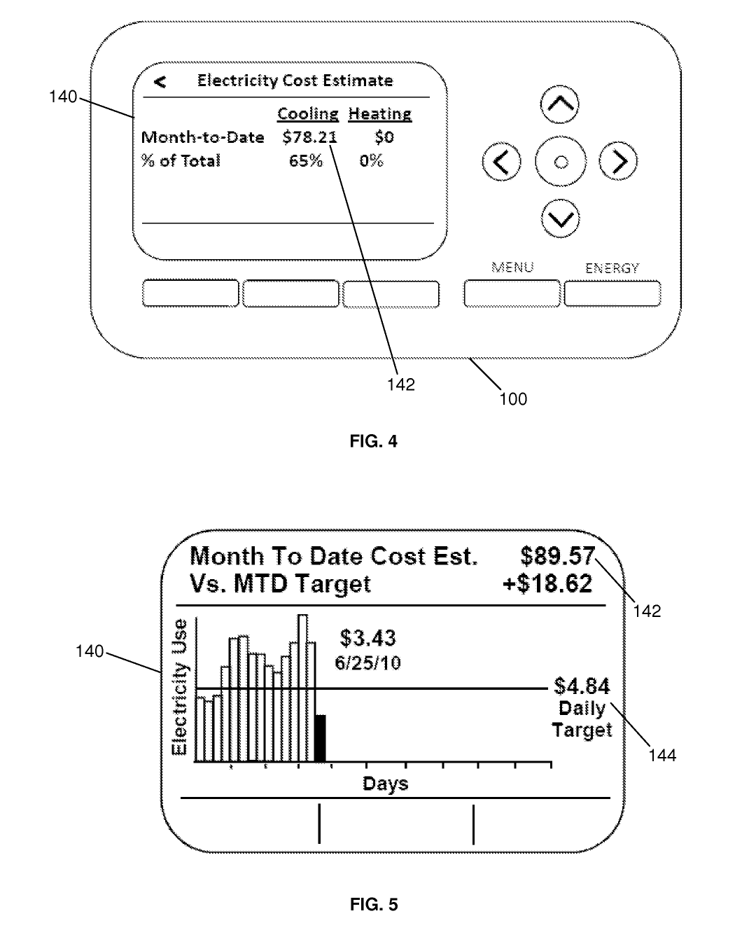

In another aspect of the present disclosure, an exemplary embodiment of a thermostat (e.g., thermostat 100, etc.) is configured to determine a sum of the energy consumption by the heat-pump or air-conditioning unit (e.g., heat-pump or air-conditioning unit 20, etc.) within a predetermined period of time, such as the current week or a given month. In this exemplary embodiment, the thermostat is also configured to display on a display device (e.g., display device 140, etc.) an indication of the sum of the energy consumption by the heat-pump or air-conditioning unit for the given month, such as shown in FIG. 4. Also shown in FIG. 4, the thermostat 100 may further be configured to display on the display device 140 an indication of a cost estimate 142 associated with the sum of the energy consumed by the heat-pump or air-conditioning unit within the given month.

According to another aspect of the present disclosure, exemplary embodiments of systems are disclosed for determining an estimate of the load of an energy consuming device is provided. In one such exemplary embodiment and with reference to FIG. 1, the system includes a thermostat 100 and a gateway 150 for determining energy consumption for energy consuming loads in a premises 24. A sensor 102 is preferably within the thermostat 100, which provides an output indicative of the sensed temperature of the space 22. The thermostat 100 further includes a processor 104 (FIG. 2) that is in communication with the sensor 102, for controlling activation of at least a compressor 21 (FIG. 1) of a heat-pump or air-conditioning unit 20.

Also in this exemplary embodiment, the system further includes a gateway 150, or an Energy Service Interface (ESI), which is in connection with the thermostat 100. The gateway 150 is configured to enable connection via the internet to a website. The gateway 150 further includes a transmitter device for transmitting wireless signals to a utility meter 34 for the premises 24 to request energy consumption information, and a receiver device for receiving wireless signals including energy consumption information from the utility meter 34. The transmitter device and receiver device may comprise a transceiver device 106 such as that described above.

The processor 104 of the thermostat 100 is configured to control activation of at least a compressor 21 of a heat-pump or air-conditioning unit 20 for controlling temperature within a space relative to a set-point temperature, and further configured to signal the gateway 150 before the thermostat 100 activates the compressor 21. Alternatively, the gateway 150 may be the control that activates the compressor 21.

The gateway 150 is configured to receive from the thermostat 100 information indicating that the compressor 21 will be activated, and responsively transmit a signal to the utility meter 34 to request energy consumption information. The gateway 150 thereafter receives a signal including a first energy consumption value that is indicative of energy consumption for the premises while the compressor 21 is “off.” Alternatively, the gateway 150 may obtain the “off” first energy consumption value after deactivation of the compressor 21. The gateway 150 is configured to transmit a signal to the utility meter 34 after activation of the compressor to request energy consumption information, and to thereafter receive a signal including a second energy consumption value. The gateway 150 is further configured to determine, from a difference between the first energy consumption value and second energy consumption value, a first estimate of the energy consumption associated with the heat-pump or air-conditioning unit 20. The gateway 150 and/or the thermostat 100 may be configured to monitor the duration of time in which the compressor 21 is activated.

Also in this exemplary embodiment, the energy consumption information from the utility meter 34 may be provided in one or more forms. For example, the energy consumption reading may be a cumulative running total of the kilowatt-hours consumed for the premises, where the difference between two such successive readings over a given time interval can be used for determining the kilowatt-hours consumed within the time interval, to thereby obtain a level of energy consumption during the time interval. The utility meter 34 may also communicate an energy consumption reading that is the rate of energy used, expressed in units of kilowatts. Accordingly, the gateway 150 may determine a difference between the first energy consumption value and the second energy consumption value, which is indicative of an increase in the rate of power usage expressed in kilowatts. The gateway 150 is configured to estimate the energy consumption of the HVAC unit based on the increase in the rate of power usage and the time duration that the HVAC unit was activated.

After deactivation of the compressor 21 of the heat-pump or air-conditioning unit 20, the gateway 150 is configured to transmit a signal to the utility meter 34 to request energy consumption information, and to receive a signal from the utility meter 34 including a third energy consumption value. The gateway 150 is further configured to determine, from a difference between the second energy consumption value and the third energy consumption value, a second estimate of the energy consumption associated with the heat-pump or air-conditioning unit 20. The difference between the second energy consumption value and the third energy consumption value is a decrease in energy consumption as a result of the deactivation of the compressor/heat-pump or air-conditioning unit 20. The gateway 150 is configured to estimate energy consumption of the HVAC unit based on the decrease in the rate of power usage, and the time duration that the HVAC unit was activated.

Continuing with this exemplary embodiment of a system for monitoring an energy consuming appliance, the gateway 150 is configured to communicate the information on the energy consumption to the thermostat 100. The thermostat 100 includes a display device 140 configured to display an indication of the energy consumption associated with the compressor and/or heat-pump or air-conditioning unit 20 to a user of the thermostat 100. The gateway 150 is further configured to communicate the information on the energy consumption associated with the compressor and/or heat-pump or air-conditioning unit 20 via the internet to an energy service provider, to thereby provide the energy provider with information on the energy consumption associated with the heat-pump or air-conditioning unit 20. This would enable energy service providers seeking to shed load during peak demand periods by turning off air-conditioner systems to evaluate which premises air-conditioning units use the most energy and would provide the most reduction in load. This information could then be utilized by the energy service provider in sending a signal to the premises 24 using the most energy to request curtailment of the heat-pump or air-conditioning unit 20 for the premises 24. To enable such curtailment, the thermostat 100 is configured to receive a signal via the gateway 150 from the energy service provider requesting curtailment of operation of the heat-pump or air-conditioning unit 20. The signal from the energy service provider would be based on the information on the energy consumption level or load associated with the particular heat-pump or air-conditioning unit 20. Additionally, the gateway 150 may be configured to determine a sum of the energy consumption by the heat-pump or air-conditioning unit 20 (and any appliance that can be controllably turned on and off) within a predetermined time period, such as the current week or month. The gateway 150 may be configured to communicate the sum of the energy consumption by the heat-pump or air-conditioning unit 20 for the given month to the thermostat 100 for display on the display device 140. Alternatively, the thermostat 100 may be configured to determine a sum of the energy consumption by the heat-pump or air-conditioning unit 20 within a given time period and to display on the display device 140 of the thermostat 100 an indication of the energy consumption for the given time period. The thermostat 100 may further be configured to display on the display device 140 an indication of cost estimate 142 associated with the sum of the energy consumed by the heat-pump or air-conditioning unit 20 within the given time period, such as shown in FIG. 4.

With the disclosed exemplary embodiments, the thermostat enables consumers to be given real time feedback on the costs of their energy consumption associated with a heat-pump or air-conditioning unit. This information may allow consumers to make smarter decisions about how and when they use electricity and reducing energy consumption. This tends to be important because people rarely cut back on consumption until they understand the impact on them as a result of specific behavior. Real time disaggregated load information for appliance energy consumption level can enhance conservation, encourage the use of programming features on the thermostat, and/or encourage equipment upgrades for inefficient appliances. Not only can the thermostat enable the consumers to understand how much electrical power a heat-pump or air-conditioning unit is consuming, the thermostat can also provide value added information on ways the consumers may save.

In an exemplary embodiment, there is provided a thermostat for monitoring the energy consumption associated with an HVAC unit. The thermostat includes a sensor for sensing temperature and a processor for controlling activation of a compressor of an HVAC unit to control the temperature in the space relative to a desired set-point temperature. The processor is configured to receive energy consumption information from a utility meter for the premises prior to activation of the compressor and subsequent to activation of the compressor, and further configured to estimate the energy consumption of the HVAC unit based at least in part upon the difference between the energy consumption prior to activation and the energy consumption subsequent to activation of the compressor. The thermostat includes a display that displays an indication of the energy consumption of the HVAC system based at least in part upon the estimate, wherein the processor of the thermostat is configured to control the display to display a graph indicating an estimated cost of the energy consumed by the heat-pump or air-conditioning unit for each day within a given month.

For example, a thermostat may be configured to display a weekly cost estimate in real time to the user, and predict from the energy consumption load profile the air-conditioning costs to the homeowner to help them with their budgeting. With reference to FIG. 2, the processor 104 of the thermostat 100 is configured to determine, from the last energy consumption reading received from the utility meter 34 each day, a difference between such daily readings that indicates the aggregate energy consumption for each day. Using a price rate for the energy consumption, the processor 104 of the thermostat 100 may be further configured to display on the display device 140 a graph showing the present day's energy consumption, such as that represented by the black highlighted bar shown in FIG. 5.

With further reference to FIG. 5, the display device 140 may further display a daily cost target 144 and a Month-to-date cost estimate 142 for the energy consumption for the premises. By multiplying the daily target by the number of days in the month to date, a difference between a Month-to-date target and the Month-to-date costs can be used to display an amount that the energy costs are above or below the month-to-date target.

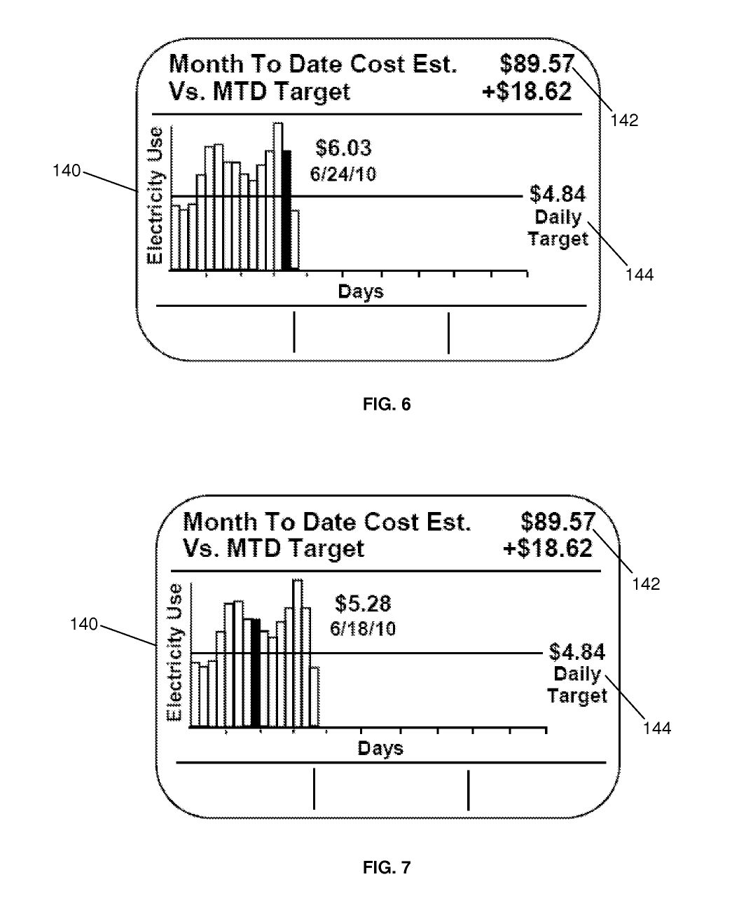

The thermostat 100 is configured to display on the display device 140 the sum of the energy consumption by the heat-pump or air-conditioning unit 20 for the given month as shown in FIG. 6. The thermostat 100 may further be configured to display on the display device 140 a cost estimate 142 associated with the sum of the energy consumed by the heat-pump or air-conditioning unit 20 within the given month. The processor 104 of the thermostat 100 is configured to determine from the energy consumption data received via the receiver device 106 the aggregate energy consumption for each day.

In response to a selection by the user, the display device 140 can display the previous day's energy consumption, as represented by the black highlighted bar shown in FIG. 6. Similarly, the user can select any day of the current Month to see how much the daily cost of energy consumption was, as shown by the black highlighted bar shown in FIG. 7. The thermostat can be configured to display the energy consumption data described above, to enable the consumer to scroll through individual days displayed on a graph on the display device 140 of the thermostat, and to select a given day see how much the daily cost of energy consumption was. For example, a user may be able to press an energy and/or menu button (e.g., FIG. 2) of a thermostat and use the arrows to scroll through and move between the different days of the given month, such between the different days shown in FIG. 5 (6/25/10), FIG. 6 (6/24/10), and FIG. 7 (6/18/10).

A thermostat according to exemplary embodiments may be configured to display energy consumption data, to thereby enable the consumer to set a monthly energy consumption cost target. The thermostat can be configured to prompt the consumer to enter a value for their monthly energy target cost and the day their billing cycle starts so they can track consumption in alignment with their actual billing cycle. For example, the user could enter a start date of the 12^{th} and a $150 target cost for the Month, which would be divided by 30 days to obtain a daily target cost of $5 per day. The display would then graph the daily energy consumption on a bar chart showing whether the consumer's energy consumption for each day was above or below their daily target cost, along with a Month-to-date total at the top of the display device 140. The display device 140 can also display an amount that the energy costs are above or below the month-to-date target to let the consumer know if they are on track to go over or under target. If they are above their target as shown in FIG. 5, the consumer will then know after viewing the display device 140 to cut back on the remaining days of the Month in order to hit their target Monthly energy consumption costs.

The thermostat 100 may be configured to collect historical data for the summer to determine an estimated energy cost that could have been saved if the user had set back the temperature setting by an additional 1 degree for the entire summer, and to responsively instruct the display device 140 to display the estimated cost. The thermostat 100 may be further be configured to compare the appliance's monthly energy consumption to historical data for the previous summer to determine a prediction of a difference in consumption, and responsively instruct the display device 140 to display a message indicating that if the current summer is like the last summer, an additional 1 degree set back of temperature setting could yield an estimated monthly savings of a determined amount. The thermostat 100 may be configured to provide an easily accessible display of a graph that concisely shows on one display the relevant energy consumption information without requiring the user to look at several charts or scroll through menus. The displayed target also enables the user to more effectively control their appliances (e.g., thermostat set-point temperature, etc.) keep their energy consumption costs under budget, as opposed to merely showing real time energy consumption data.

According to another aspect of the present disclosure, there is provided a system for monitoring an energy consuming load in a premises. The system includes a gateway 150 (FIG. 1), or an ESI device, for enabling connection via the internet to a website. In this example. the gateway 150 is in communication with a plurality of energy consuming appliances or loads including one or more of a thermostat 100, an electric water heater 28, a refrigerator 36, a pool water pump 32, a media center, etc.

The gateway 150 is in communication with a plurality of switch controls for a plurality of energy consuming loads in the premises, including one or more devices such as a thermostat 100, an electric water heater 28, and a refrigerator 36 of a premises. The gateway 150 is configured to receive a signal from one or more of the thermostat 100, the electric water heater 28, and the refrigerator 36 indicating that the energy consuming load is activated, and configured to receive energy consumption information from a utility meter for the premises when the energy consuming load is operating and when the energy consuming load is not operating. The gateway 150 is further configured to estimate the energy consumption of the energy consuming load unit based at least in part upon the difference between the energy consumption during operation and the energy consumption during non-operation of the energy consuming load.

The gateway 150 may include, for example, a transmitter device for transmitting wireless signals to a utility meter 34 for the premises to request energy consumption information and a receiver device 106 for receiving wireless signals including energy consumption information from the utility meter 34. The gateway 150 may receive a signal from one or more of the thermostat 100, the electric water heater 28, the refrigerator 36, the pool water pump 32, etc. indicating that the energy consuming load is operating. The electric water heater 28, refrigerator 36, pool water pump 32, etc. may be connected to a smart outlet or a high amp load control switch device, which is configured to control any appliance plugged into it and to communicate with the gateway 150.

Accordingly, the gateway 150 is configured to receive a signal from one or more of the thermostat 100, the electric water heater 28, the refrigerator 36, the pool water pump 32, etc. indicating that the energy consuming device is operating, and to responsively transmit a signal to the utility meter 34 to request energy consumption information and to receive a signal from the utility meter including a first energy consumption value. The gateway 150 is further configured to transmit a signal to the utility meter 34 after deactivation of the energy consuming load, to request energy consumption information and thereafter receive a signal from the utility meter 34 including a second energy consumption value. After receiving the energy consumption information, the gateway 150 is further configured to determine, from a difference between the first and second energy consumption values, an estimate of the energy consumption associated with the energy consuming load.

For example, if the gateway 150 receives a signal from a controller 26 of an electric water heater 28 (or an associated smart outlet) that indicates the electric water heater 28 was activated and/or operating, the gateway 150 is configured to responsively transmit a signal to the utility meter 34 to request energy consumption information, and to receive a signal from the utility meter 34 including a first energy consumption value. Following deactivation of the energy consuming load, the gateway 150 is configured to transmit a signal to the utility meter 34 to request energy consumption information, and to receive a signal from the utility meter 34 including a second energy consumption value. The gateway 150 is further configured to determine, from a difference between the first and second energy consumption values, an estimate of the energy consumption associated with the activated energy consuming appliance. The gateway 150 may further be configured to monitor the activation of the appliance to detect a rapid frequency of activation/deactivation, or an elevated energy consumption level for the appliance, which may be indicative of a fault of the appliance. In response to detecting activation or energy consumption information indicative of a fault, the gateway 150 is configured to responsively turn off the appliance and notify an occupant or service provider of the fault.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Specific dimensions disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). Similarly, it is envisioned that disclosure of two or more ranges of values for a parameter (whether such ranges are nested, overlapping or distinct) subsume all possible combination of ranges for the value that might be claimed using endpoints of the disclosed ranges.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A thermostat for monitoring energy consumption associated with an HVAC unit having a compressor, the thermostat comprising:
a sensor operable for providing an output indicative of a temperature within a space of a premises;
a processor operable for controlling activation of at least the compressor of the HVAC unit to control temperature in the space relative to a desired set-point temperature, the processor configured to receive energy consumption information from a utility meter for the premises prior to activation of the compressor and subsequent to activation of the compressor, the processor further configured to estimate energy consumption of the HVAC unit based at least in part upon the difference between the energy consumption prior to activation and the energy consumption subsequent to activation of the compressor; and
a display device operable for displaying a graph indicating estimated cost of energy consumed by the HVAC unit for days within a given month.

2. The thermostat of claim 1, wherein the thermostat is configured to enable a user to select a day within the given month and configured such that in response to the user's selection, the display device displays the estimated cost for the selected day.

3. The thermostat of claim 1, wherein the thermostat is configured to enable a user to scroll through individual days displayed in the graph on the display device and to select a given day to thereby cause the display device to display the estimated cost for the selected day.

4. The thermostat of claim 1, wherein the display device is operable for displaying an indication of energy consumption of the HVAC unit based at least in part upon the estimate of energy consumption.

5. The thermostat of claim 1, wherein the thermostat is configured to monitor the duration of time in which the compressor is activated.

6. The thermostat of claim 1, wherein the thermostat is configured to receive energy consumption information via wireless signals from the utility meter.

7. The thermostat of claim 1, wherein the thermostat is configured to receive energy consumption information from the utility meter for the premises in terms of the rate of power usage expressed in units of kilowatts, such that the difference between energy consumption prior to and subsequent to activation of the compressor is indicative of an increase in the rate of power usage expressed in kilowatts, and the estimate of consumption is based on the increase in the rate of power usage and the time duration that the HVAC unit was activated.

8. The thermostat of claim 1, wherein the processor is configured to obtain information about consumption after deactivation of the compressor of the HVAC unit and to estimate consumption of the HVAC unit based at least in part upon the difference between the energy consumption prior to and subsequent to deactivation of the compressor.

9. The thermostat of claim 1, wherein the thermostat is configured to determine a sum of the energy consumption by the HVAC unit within a given time period and to display on the display device an indication of the energy consumption for the given time period.

10. The thermostat of claim 1, further comprising:
a transmitter device configured to transmit wireless signals; and
a receiver device configured to receive wireless signals, wherein:
the processor is configured to communicate via the transmitter device to the utility meter to request energy consumption information prior to activation of the compressor, and to receive via the receiver device a first energy consumption value from the utility meter that is indicative of energy consumption for the premises prior to activation of the compressor;
the processor is configured to communicate via the transmitter device to the utility meter to request energy consumption information after activation of the compressor, and to receive via the receiver device a second energy consumption value indicative of energy consumption after activation of the compressor;
the processor is configured to determine, from a difference between the first and second energy consumption values, a first estimate of the energy consumption of the HVAC unit; and
the difference between the first energy consumption value and the second energy consumption value is indicative of an increase in the rate of power usage, and the consumption of the HVAC unit is estimated based on the increase in the rate of power usage and the time duration that the HVAC unit was activated.

11. The thermostat of claim 10, wherein the processor is configured to communicate via the transmitter device to the utility meter to request energy consumption information after deactivation of the compressor, and to receive via the receiver device a third energy consumption value, and the processor is configured to determine from a difference between the second energy consumption value and the third energy consumption value a second estimate of the energy consumption for the HVAC unit; and wherein:
the difference between the second and third energy consumption values is a decrease that is indicative of the rate of power usage of the HVAC unit, and the processor is configured to estimate energy consumption of the HVAC unit based on the decrease in the rate of power usage and the time duration that the HVAC unit was activated; and/or
the thermostat is configured to obtain energy consumption information from the utility meter in terms of the power usage, and the processor is configured to estimate energy consumption of the HVAC unit based on the difference between the third energy consumption value and the first energy consumption value for the time duration that the HVAC unit was activated.

12. The thermostat of claim 1, wherein the processor is configured to control the display device to display the graph indicating the estimated cost of the energy consumed by the HVAC unit for each day within a given month.

13. The thermostat of claim 1, wherein the HVAC unit comprises a heat-pump or air-conditioning unit, such that the thermostat is operable for monitoring energy consumption associated with the heat-pump or air-conditioning unit.

14. A system comprising the thermostat of claim 1, and further comprising a gateway for enabling connection via the internet to a website, wherein the thermostat is configured to communicate information on energy consumption associated with the HVAC unit to the gateway to permit an energy service provider to access the information on energy consumption for the HVAC unit.

15. The system of claim 14, wherein the thermostat is configured to receive via the gateway a signal from an energy service provider requesting curtailment of operation of the HVAC unit based on the information on the energy consumption for the HVAC unit.

16. A thermostat operable for displaying information relating to energy consumption associated with an energy consuming load in a premise, the thermostat comprising:
a display device; and
a processor configured to receive a signal including energy consumption information, the processor further configured to control the display device to display a graph indicating an estimated cost of energy consumed for days within a given month.

17. The thermostat of claim 16, wherein the thermostat is configured to allow a user to select a day within the given month to view the estimated cost for the selected day.

18. The thermostat of claim 16, wherein the thermostat is configured to enable a user to select a day within the given month and configured such that in response to the user's selection, the display device displays the estimated cost for the selected day.

19. The thermostat of claim 16, wherein the thermostat is configured to enable a user to scroll through individual days displayed in the graph on the display device and to select a given day to thereby cause the display device to display the estimated cost for the selected day.

20. A system for monitoring energy consumption for an energy consuming load in a premises that is supplied with power monitored by a utility meter, the system comprising:
a thermostat including a display device;
a gateway in connection with the thermostat, for enabling connection via the internet to a website, the gateway including:
a transmitter operable for transmitting wireless signals to a utility meter for the premises to request energy consumption information; and
a receiver operable for receiving wireless signals including energy consumption information from the utility meter;
wherein at least one of the gateway and the thermostat is configured to estimate energy consumption of the energy consuming load based at least in part upon a difference between energy consumption during operation and energy consumption during non-operation of the energy consuming load; and
wherein the display device is operable for displaying a graph indicating estimated cost of energy consumed by the energy consuming load for days within a given month.
